(19) United States
(12) Patent Application Publication
(10) Pub. No.: US 2012/0073553 A1
(43) Pub. Date: Mar. 29, 2012

(54) EXHAUST VALVE TIMING FOR SPLIT-CYCLE ENGINE

(75) Inventor: Ford Allen Phillips, San Antonio, TX (US)

(73) Assignee: SCUDERI GROUP, LLC, West Springfield, MA (US)

(21) Appl. No.: 13/247,811

(22) Filed: Sep. 28, 2011

Related U.S. Application Data
(60) Provisional application No. 61/404,239, filed on Sep. 29, 2010.

(51) Int. Cl. F02B 33/22

(52) U.S. Cl. 123/70 R

(57) ABSTRACT

The engines, engine components, and related methods disclosed herein generally involve closing an exhaust valve through which exhaust gasses and other combustion products are evacuated from the expansion cylinder of a split-cycle engine before opening a crossover expansion valve through which a fresh charge of air and/or fuel is supplied to the expansion cylinder. The exhaust valve is preferably closed as late as possible after a combustion event, but with sufficient margin before opening of the crossover expansion valve and, in the case of an inwardly-opening exhaust valve, before valve-to-piston contact occurs. Preferably, the exhaust valve is closed about 0 CA degrees to about 15 CA degrees before the crossover expansion valve is opened.

### CROSS-REFERENCE TO RELATED APPLICATIONS

This application claims the benefit of priority of U.S. Provisional Patent Application No. 61/404,239, filed on Sep. 29, 2010, the entire contents of which are incorporated herein by reference.

### FIELD

The present invention relates to internal combustion engines. More particularly, the invention relates to exhaust valve timing for split-cycle engines.

### BACKGROUND

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (“CA”)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine generally comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

A split-cycle air hybrid engine combines a split-cycle engine with an air reservoir (also commonly referred to as an air tank) and various controls. This combination enables the engine to store energy in the form of compressed air in the air reservoir. The compressed air in the air reservoir is later used in the expansion cylinder to power the crankshaft. In general, a split-cycle air hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

FIG. 1 illustrates one exemplary embodiment of a prior art split-cycle air hybrid engine. The split-cycle engine 100 replaces two adjacent cylinders of a conventional engine with a combination of one compression cylinder 102 and one expansion cylinder 104. The compression cylinder 102 and the expansion cylinder 104 are formed in an engine block in which a crankshaft 106 is rotatably mounted. Upper ends of the cylinders 102, 104 are closed by a cylinder head 130. The crankshaft 106 includes axially displaced and angularly offset first and second crank throws 126, 128, having a phase angle therebetween. The first crank throw 126 is pivotally joined by a first connecting rod 138 to a compression piston 110, and the second crank throw 128 is pivotally joined by a second connecting rod 140 to an expansion piston 120 to reciprocate the pistons 110, 120 in their respective cylinders 102, 104 in a timed relation determined by the angular offset of the crank throws and the geometric relationships of the cylinders, crank, and pistons. Alternative mechanisms for relating the motion and timing of the pistons can be utilized if desired. The rotational direction of the crankshaft and the relative motions of the pistons near their bottom dead center (BDC) positions are indicated by the arrows associated in the drawings with their corresponding components.

The four strokes of the Otto cycle are thus “split” over the two cylinders 102 and 104 such that the compression cylinder 102 contains the intake and compression strokes and the expansion cylinder 104 contains the expansion and exhaust strokes. The Otto cycle is therefore completed in these two cylinders 102, 104 once per crankshaft 106 revolution (360 degrees CA).

During the intake stroke, intake air is drawn into the compression cylinder 102 through an inwardly-opening (opening inward into the cylinder and toward the piston) poppet intake valve 108. During the compression stroke, the compression piston 110 pressurizes the air charge and drives the air charge through a crossover passage 112, which acts as the intake passage for the expansion cylinder 104. The engine 100 can have one or more crossover passages 112.

The volumetric (or geometric) compression ratio of the compression cylinder 102 of the split-cycle engine 100 (and for split-cycle engines in general) is herein referred to as the “compression ratio” of the split-cycle engine. The volumetric (or geometric) compression ratio of the expansion cylinder 104 of the engine 100 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its BDC position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high volumetric compression ratios (e.g., 20 to 1, 30 to 1, 40 to 1, or greater) within the compression cylinder 102, an outwardly-opening (opening outwardly away from the cylinder and piston) poppet crossover compression (XovrC) valve 114 at the inlet of the crossover passage 112 is used to control flow from the compression cylinder 102 into the crossover passage 112. Due to very high volumetric compression ratios (e.g., 20 to 1, 30 to 1, 40 to 1, or greater) within the expansion cylinder 104, an outwardly-opening poppet crossover expansion (XovrE) valve 116 at the outlet of the crossover passage 112 controls flow from the crossover passage 112 into the expansion cylinder 104. The actuation rates and phasing of the XovrC and XovrE valves 114, 116 are timed to maintain pressure in the crossover passage 112 at a high minimum pressure (typically 20 bar or higher at full load) during all four strokes of the Otto cycle.

At least one fuel injector 118 injects fuel into the pressurized air at the exit end of the crossover passage 112 in coordination with the XovrE valve 116 opening. Alternatively, or in addition, fuel can be injected directly into the expansion cylinder 104. The fuel-air charge fully enters the expansion cylinder 104 shortly after the expansion piston 120 reaches its TDC position. As the piston 120 begins its descent from its TDC position, and while the XovrE valve 116 is still open, one or more spark plugs 122 are fired to initiate combustion (typically between 10 to 20 degrees CA after TDC of the expansion piston 120). Combustion can be initiated while the expansion piston is between 1 and 30 degrees CA past its TDC position. More preferably, combustion can be initiated while the expansion piston is between 5 and 25 degrees CA past its TDC position. Most preferably, combustion can be initiated while the expansion piston is between 10 and 20 degrees CA past its TDC position. Additionally, combustion can be initiated through other ignition devices and/or methods, such as with glow plugs, microwave ignition devices, or through compression ignition methods.

The XovrE valve 116 is then closed before the resulting combustion event enters the crossover passage 112. The combustion event drives the expansion piston 120 downward in a power stroke. Exhaust gases are pumped out of the expansion cylinder 104 through an inwardly-opening poppet exhaust valve 124 during the exhaust stroke.

With the split-cycle engine concept, the geometric engine parameters (i.e., bore, stroke, connecting rod length, compression ratio, etc.) of the compression and expansion cylinders are generally independent from one another. For example, the crank throws 126, 128 for the compression cylinder 102 and expansion cylinder 104, respectively, have different radii and are phased apart from one another with TDC of the expansion piston 120 occurring prior to TDC of the compression piston 110. This independence enables the split-cycle engine to potentially achieve higher efficiency levels and greater torques than typical four-stroke engines.

The geometric independence of engine parameters in the split-cycle engine 100 is also one of the main reasons why pressure can be maintained in the crossover passage 112 as discussed earlier. Specifically, the expansion piston 120 reaches its TDC position prior to the compression piston 110 reaching its TDC position by a discrete phase angle (typically between 10 and 30 crank angle degrees). This phase angle, together with proper timing of the XovrC valve 114 and the XovrE valve 116, enables the split-cycle engine 100 to maintain pressure in the crossover passage 112 at a high minimum pressure (typically 20 bar absolute or higher during full load operation) during all four strokes of its pressure/volume cycle. That is, the split-cycle engine 100 is operable to time the XovrC valve 114 and the XovrE valve 116 such that the XovrC and XovrE valves 114, 116 are both open for a substantial period of time (or period of crankshaft rotation) during which the expansion piston 120 descends from its TDC position towards its BDC position and the compression piston 110 simultaneously ascends from its BDC position towards its TDC position. During the period of time (or crankshaft rotation) that the crossover valves 114, 116 are both open, a substantially equal mass of gas is transferred (1) from the compression cylinder 102 into the crossover passage 112 and (2) from the crossover passage 112 to the expansion cylinder 104. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 114 and XovrE valve 116 are both closed to maintain the mass of trapped gas in the crossover passage 112 at a substantially constant level. As a result, the pressure in the crossover passage 112 is maintained at a predetermined minimum pressure during all four strokes of the engine's pressure/volume cycle.

For purposes herein, the method of opening the XovrC 114 and XovrE 116 valves while the expansion piston 120 is descending from TDC and the compression piston 110 is ascending toward TDC in order to simultaneously transfer a substantially equal mass of gas into and out of the crossover passage 112 is referred to as the “push-pull” method of gas transfer. It is the push-pull method that enables the pressure in the crossover passage 112 of the engine 100 to be maintained at typically 20 bar or higher during all four strokes of the engine's cycle when the engine is operating at full load.

The crossover valves 114, 116 are actuated by a valve train that includes one or more cams (not shown). In general, a cam-driven mechanism includes a camshaft mechanically linked to the crankshaft. One or more cams are mounted to the camshaft, each having a contoured surface that controls the valve lift profile of the valve event (i.e., the event that occurs during a valve actuation). The XovrC valve 114 and the XovrE valve 116 each can have its own respective cam and/or its own respective camshaft. As the XovrC and XovrE cams rotate, eccentric portions thereof impart motion to a rocker arm, which in turn imparts motion to the valve, thereby lifting (opening) the valve off of its valve seat. As the cam continues to rotate, the eccentric portion passes the rocker arm and the valve is allowed to close.

The split-cycle air hybrid engine 100 also includes an air reservoir (tank) 142, which is operatively connected to the crossover passage 112 by an air reservoir tank valve 152. Embodiments with two or more crossover passages 112 may include a tank valve 152 for each crossover passage 112 which connect to a common air reservoir 142, may include a single valve which connects all crossover passages 112 to a common air reservoir 142, or each crossover passage 112 may operatively connect to separate air reservoirs 142.

The tank valve 152 is typically disposed in an air tank port 154, which extends from the crossover passage 112 to the air tank 142. The air tank port 154 is divided into a first air tank port section 156 and a second air tank port section 158. The first air tank port section 156 connects the air tank valve 152 to the crossover passage 112, and the second air tank port section 158 connects the air tank valve 152 to the air tank 142. The volume of the first air tank port section 156 includes the volume of all additional recesses which connect the tank valve 152 to the crossover passage 112 when the tank valve 152 is closed. Preferably, the volume of the first air tank port section 156 is small relative to the second air tank port section 158. More preferably, the first air tank port section 156 is substantially non-existent, that is, the tank valve 152 is most preferably disposed such that it is flush against the outer wall of the crossover passage 112.

The tank valve 152 may be any suitable valve device or system. For example, the tank valve 152 may be an active valve which is activated by various valve actuation devices (e.g., pneumatic, hydraulic, cam, electric, or the like). Additionally, the tank valve 152 may comprise a tank valve system with two or more valves actuated with two or more actuation devices.

The air tank 142 is utilized to store energy in the form of compressed air and to later use that compressed air to power the crankshaft 106. This mechanical means for storing potential energy provides numerous potential advantages over the current state of the art. For instance, the split-cycle air hybrid engine 100 can potentially provide many advantages in fuel efficiency gains and NOx emissions reduction at relatively low manufacturing and waste disposal costs in relation to other technologies on the market, such as diesel engines and electric-hybrid systems.

The engine 100 typically runs in a normal operating or firing (NF) mode (also commonly called the engine firing (EF) mode) and one or more of four basic air hybrid modes. In the EF mode, the engine 100 functions normally as previously described in detail herein, operating without the use of the air tank 142. In the EF mode, the air tank valve 152 remains closed to isolate the air tank 142 from the basic split-cycle engine. In the four air hybrid modes, the engine 100 operates with the use of the air tank 142.

The four basic air hybrid modes include:

1) Air Expander (AE) mode, which includes using compressed air energy from the air tank 142 without combustion;

2) Air Compressor (AC) mode, which includes storing compressed air energy into the air tank 142 without combustion;

3) Air Expander and Firing (AEF) mode, which includes using compressed air energy from the air tank 142 with combustion; and

4) Firing and Charging (FC) mode, which includes storing compressed air energy into the air tank 142 with combustion.

Further details on split-cycle engines can be found in U.S. Pat. No. 6,543,225 entitled Split Four Stroke Cycle Internal Combustion Engine and issued on Apr. 8, 2003; and U.S. Pat. No. 6,952,923 entitled Split-Cycle Four-Stroke Engine and issued on Oct. 11, 2005, each of which is incorporated by reference herein in its entirety.

Further details on air hybrid engines are disclosed in U.S. Pat. No. 7,353,786 entitled Split-Cycle Air Hybrid Engine and issued on Apr. 8, 2008; U.S. Patent Application No. 61/365,343 entitled Split-Cycle Air Hybrid Engine and filed on Jul. 18, 2010; and U.S. Patent Application No. 61/313,831 entitled Split-Cycle Air Hybrid Engine and filed on Mar. 15, 2010, each of which is incorporated by reference herein in its entirety.

In the engine 100 of FIG. 1, inadequate evacuation of exhaust gasses from the expansion cylinder 104 can cause the temperature within the expansion cylinder to remain very high. This high temperature can trigger undesirable pre-ignition of fuel added to the expansion cylinder for a future expansion stroke. Inadequate evacuation of exhaust gasses also reduces the efficiency of the engine 100, since exhaust gas trapped in the expansion cylinder 104 is needlessly compressed during a portion of the exhaust stroke. Accordingly, there is a need for engines, engine components, and related methods which are characterized by improved exhaust valve timing.

### SUMMARY

The engines, engine components, and related methods disclosed herein generally involve closing an exhaust valve through which exhaust gasses and other combustion products are evacuated from the expansion cylinder before opening a crossover expansion valve through which a fresh charge of air and/or fuel is supplied to the expansion cylinder. The exhaust valve is preferably closed as late as possible after a combustion event, but with sufficient margin before opening of the crossover expansion valve and, in the case of an inwardly-opening exhaust valve, before valve-to-piston contact occurs. Preferably, the exhaust valve is closed about 0 CA degrees to about 15 CA degrees before the crossover expansion valve is opened. More preferably, the exhaust valve is closed about 3 CA degrees to about 10 CA degrees before the crossover expansion valve is opened. Even more preferably, the exhaust valve is closed about 3 CA degrees to about 5 CA degrees before the crossover expansion valve is opened.

In one aspect of at least one embodiment of the invention, an engine is provided that includes a crankshaft rotatable about a crankshaft axis, a compression piston slidably received within a compression cylinder and operatively connected to the crankshaft such that the compression piston reciprocates through an intake stroke and a compression stroke during a single rotation of the crankshaft, and an expansion piston slidably received within an expansion cylinder and operatively connected to the crankshaft such that the expansion piston reciprocates through an expansion stroke and an exhaust stroke during a single rotation of the crankshaft. The engine also includes a crossover passage interconnecting the compression and expansion cylinders, the crossover passage including at least a crossover expansion valve disposed therein, and an exhaust valve through which exhaust gasses can be evacuated from the expansion cylinder. The crossover expansion valve is opened between about 0 CA degrees and about 15 CA degrees after the exhaust valve is closed.

Related aspects of at least one embodiment of the invention provide an engine, e.g., as described above, in which the crossover expansion valve is opened between about 3 CA degrees and about 10 CA degrees after the exhaust valve is closed.

Related aspects of at least one embodiment of the invention provide an engine, e.g., as described above, in which the crossover expansion valve is opened between about 3 CA degrees and about 5 CA degrees after the exhaust valve is closed.

Related aspects of at least one embodiment of the invention provide an engine, e.g., as described above, in which the crossover expansion valve is opened about 4 CA degrees after the exhaust valve is closed.

Related aspects of at least one embodiment of the invention provide an engine, e.g., as described above, in which the crossover expansion valve controls fluid flow between the crossover passage and the expansion cylinder.

Related aspects of at least one embodiment of the invention provide an engine, e.g., as described above, in which the crossover expansion valve is outwardly-opening.

Related aspects of at least one embodiment of the invention provide an engine, e.g., as described above, in which the exhaust valve is inwardly-opening.

Related aspects of at least one embodiment of the invention provide an engine, e.g., as described above, in which the exhaust valve is closed before the expansion piston reaches its TDC position.

Related aspects of at least one embodiment of the invention provide an engine, e.g., as described above, in which the crossover expansion valve is opened before the expansion piston reaches its TDC position.

Related aspects of at least one embodiment of the invention provide an engine, e.g., as described above, in which the crossover expansion valve is opened after the expansion piston reaches its TDC position.

In another aspect of at least one embodiment of the invention, a method of operating a split-cycle engine is provided that includes opening an exhaust valve of the engine during an exhaust stroke such that exhaust gasses are evacuated from an expansion cylinder of the engine through the exhaust valve. The method also includes closing the exhaust valve during the exhaust stroke and before an expansion piston disposed in the expansion cylinder reaches its TDC position. The method also includes opening a crossover expansion valve of the engine between about 0 CA degrees and about 15 CA degrees after closing the exhaust valve such that air flows from a crossover passage of the engine, through the crossover expansion valve, and into the expansion cylinder.

Related aspects of at least one embodiment of the invention provide a method, e.g., as described above, in which the crossover expansion valve is opened between about 3 CA degrees and about 10 CA degrees after the exhaust valve is closed.

Related aspects of at least one embodiment of the invention provide a method, e.g., as described above, in which the crossover expansion valve is opened between about 3 CA degrees and about 5 CA degrees after the exhaust valve is closed.

Related aspects of at least one embodiment of the invention provide a method, e.g., as described above, in which the crossover expansion valve is opened about 4 CA degrees after the exhaust valve is closed.

Related aspects of at least one embodiment of the invention provide a method, e.g., as described above, in which the crossover expansion valve is outwardly-opening.

Related aspects of at least one embodiment of the invention provide a method, e.g., as described above, in which the exhaust valve is inwardly-opening.

Related aspects of at least one embodiment of the invention provide a method, e.g., as described above, in which the crossover expansion valve is opened before the expansion piston reaches its TDC position.

Related aspects of at least one embodiment of the invention provide a method, e.g., as described above, in which the crossover expansion valve is opened after the expansion piston reaches its TDC position.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1 is a schematic diagram of a prior art split-cycle air hybrid engine;

FIG. 2 is a schematic diagram of one exemplary embodiment of a split-cycle air hybrid engine having improved exhaust valve timing;

FIG. 3A is a schematic diagram of the expansion side of the split-cycle engine of FIG. 2 during an expansion stroke;

FIG. 3B is a schematic diagram of the expansion side of the split-cycle engine of FIG. 2 during an exhaust stroke;

FIG. 3C is a schematic diagram of the expansion side of the split-cycle engine of FIG. 2 during an exhaust stroke at a point in time later than that shown in FIG. 3B;

FIG. 3D is a schematic diagram of the expansion side of the split-cycle engine of FIG. 2 during an exhaust stroke at a point in time later than that shown in FIG. 3C;

FIG. 3E is a schematic diagram of the expansion side of the split-cycle engine of FIG. 2 during an exhaust stroke at a point in time later than that shown in FIG. 3D;

FIG. 4A is a graphical illustration of valve opening and closing timings for one exemplary embodiment of a split-cycle engine having improved exhaust valve timing;

FIG. 4B is a graphical illustration of valve opening and closing timings for the split-cycle engine of FIG. 4A; and

FIG. 4C is a graphical illustration of valve opening and closing timings for the split-cycle engine of FIGS. 4A-4B.

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The term “air” is used herein to refer both to air and mixtures of air and other substances such as fuel or exhaust products. The term “fluid” is used herein to refer to both liquids and gasses. Features shown in a particular figure that are the same as, or similar to, features shown in another figure are designated by like reference numerals.

For purposes herein, a valve opening event is the point at which the valve has opened enough to permit a non-negligible flow through the valve open area. As the initial valve movement and resulting start of fluid flow through the valve opening is very gradual, the crank angle at which a valve lift increases to 5-7% of potential maximum peak valve lift is utilized as the reference crank angle for valve opening.

Also for purposes herein, a valve closing event is the point at which the valve has closed enough to halt a non-negligible flow through the valve open area. As the final valve movement and resulting halt in fluid flow through the valve opening is very gradual, the crank angle at which a valve lift decreases to 5-7% of potential maximum peak valve lift is utilized as the reference crank angle for valve closing.

Thus, a valve becomes “opened” for reference purposes when it has moved away from its seat to 5-7% of peak lift, and a valve becomes “closed” for reference purposes when it moves towards its seat to within 5-7% of peak lift. A reference valve lift number can be chosen which is “rounded” to a single decimal digit (one tenth) of a millimeter for simplicity. For example, with a potential maximum peak valve lift (such as the crossover valves) of 3-4 mm, 0.2 mm can be chosen as the reference lift for valve opening and closing crank angles. Similarly, for potential maximum peak valve lifts of 8-10 mm (such as the intake and exhaust valves), 0.5 mm can be chosen as the reference lift for valve opening and closing crank angles.

The engines, engine components, and related methods disclosed herein generally involve closing an exhaust valve through which exhaust gasses and other combustion products are evacuated from an expansion cylinder before opening a crossover expansion valve through which a fresh charge of air and/or fuel is supplied to the expansion cylinder. The exhaust valve is preferably closed as late as possible after a combustion event, but with sufficient margin before opening of the crossover expansion valve and, in the case of an inwardly-opening exhaust valve, before valve-to-piston contact occurs. Preferably, the exhaust valve is closed about 0 CA degrees to about 15 CA degrees before the crossover expansion valve is opened. More preferably, the exhaust valve is closed about 3 CA degrees to about 10 CA degrees before the crossover expansion valve is opened. Even more preferably, the exhaust valve is closed about 3 CA degrees to about 5 CA degrees before the crossover expansion valve is opened.

Closing the exhaust valve as late as possible maximizes the amount of hot exhaust gas that is evacuated from the expansion cylinder during the exhaust stroke. This advantageously prevents residual heat in the expansion cylinder from causing pre-ignition of a fresh incoming fuel charge. In addition, if the exhaust valve is closed too early, the expansion piston must perform efficiency-robbing compression work on the gasses remaining in the expansion cylinder after the exhaust valve is closed. Furthermore, closing the exhaust valve as late as possible helps maximize the pressure difference between the crossover passage and the expansion cylinder when the crossover expansion valve is subsequently opened, thereby improving air/fuel mixing in the expansion cylinder.

While it is generally desirable to close the exhaust valve as late as possible during the exhaust stroke, it is also desirable to close the exhaust valve before opening the crossover expansion valve. This prevents “blow through,” in which fresh air and/or fuel charge entering the expansion cylinder escapes through the exhaust valve. Blow through can cause parasitic pressure losses, which reduce the overall efficiency of the engine. In addition, blow through can result in unburned fuel entering the exhaust system, harming emissions and reducing fuel economy. In the case of inwardly-opening exhaust valves, the exhaust valve must also be closed before piston-to-valve contact occurs.

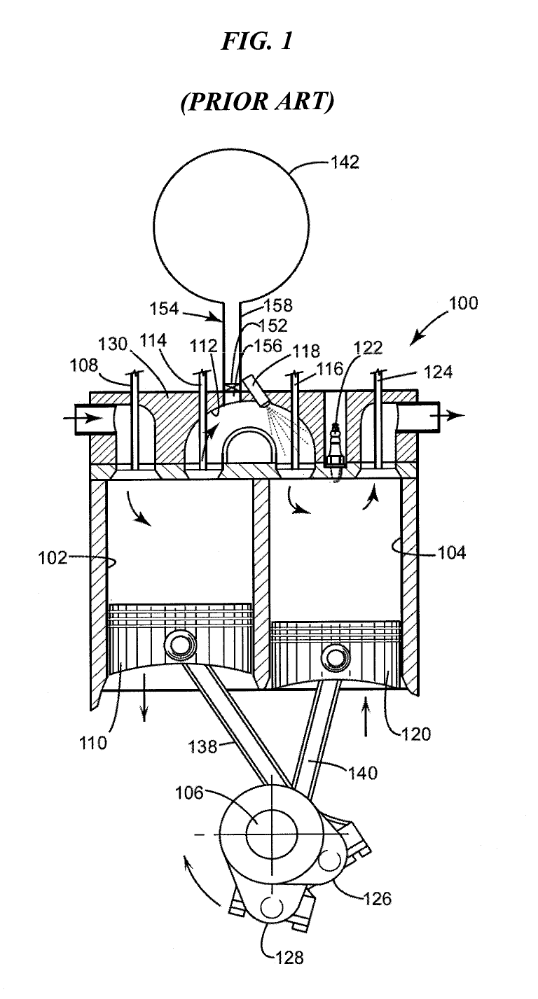

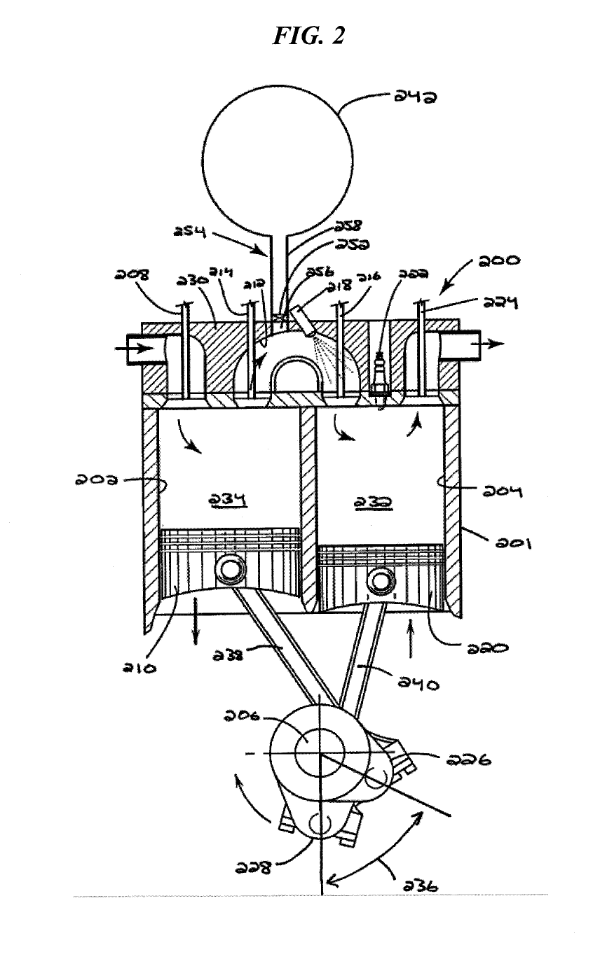

FIG. 2 illustrates one exemplary embodiment of an air hybrid split-cycle engine 200 according to the present invention. A detailed description of the structure and operation of the engine 200 is omitted here for the sake of brevity, it being understood that the structure and operation of the engine 200 is similar to that of the engine 100 of FIG. 1, except as described herein. The engine 200 of FIG. 2 differs from the engine 100 of FIG. 1 particularly with regard to the timing of the crossover expansion valve and exhaust valve opening and closing events.

The engine 200 includes a compression cylinder 202 with a compression piston 210 reciprocally disposed therein and an expansion cylinder 204 with an expansion piston 220 reciprocally disposed therein. Upper ends of the cylinders 202, 204 are closed by a cylinder head 230. During the intake stroke, intake air is drawn into the compression cylinder 202 through an intake valve 208. During the compression stroke, the compression piston 210 pressurizes the air charge and drives the air charge through a crossover passage 212, which acts as the intake passage for the expansion cylinder 204. The engine 200 can have one or more crossover passages 212. An outwardly-opening crossover compression valve 214 at the inlet of the crossover passage 212 is used to control flow from the compression cylinder 202 into the crossover passage 212. An outwardly-opening crossover expansion valve 216 at the outlet of the crossover passage 212 controls flow from the crossover passage 212 into the expansion cylinder 204.

At least one fuel injector 218 injects fuel into the pressurized air at the exit end of the crossover passage 212 and/or directly into the expansion cylinder 204. As the expansion piston 220 begins its descent from its TDC position, one or more spark plugs 222 are fired to initiate combustion, which drives the expansion piston 220 downward in a power stroke. Exhaust gases are pumped out of the expansion cylinder 204 through an exhaust valve 224 during the exhaust stroke. The engine 200 can preferably include an air tank 242, and can thus be operable in any of the air hybrid modes described above.

While the illustrated crossover expansion valve 216 is outwardly-opening, and the illustrated exhaust valve 224 is inwardly-opening, any type of valve can be used without departing from the scope of the present invention. For example, both valves can be inwardly-opening, both can be outwardly-opening, or the crossover expansion valve 216 can be inwardly-opening while the exhaust valve 224 is outwardly-opening. One or both of the crossover expansion valve 216 and the exhaust valve 224 can be actuated by a variable valve actuation system such that the opening timing, opening rate, closing timing, and/or closing rate of each valve can be adjusted. Exemplary variable valve actuation systems are disclosed in U.S. Provisional Application No. 61/436,735, filed on Jan. 27, 2011 and entitled “Lost-Motion Variable Valve Actuation System with Cam Phaser,” the entire contents of which are incorporated herein by reference.

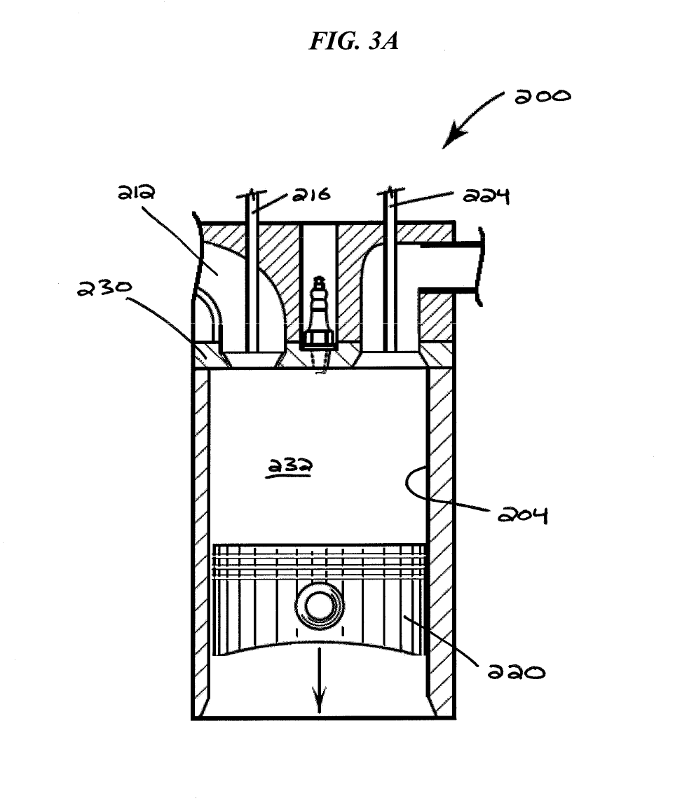

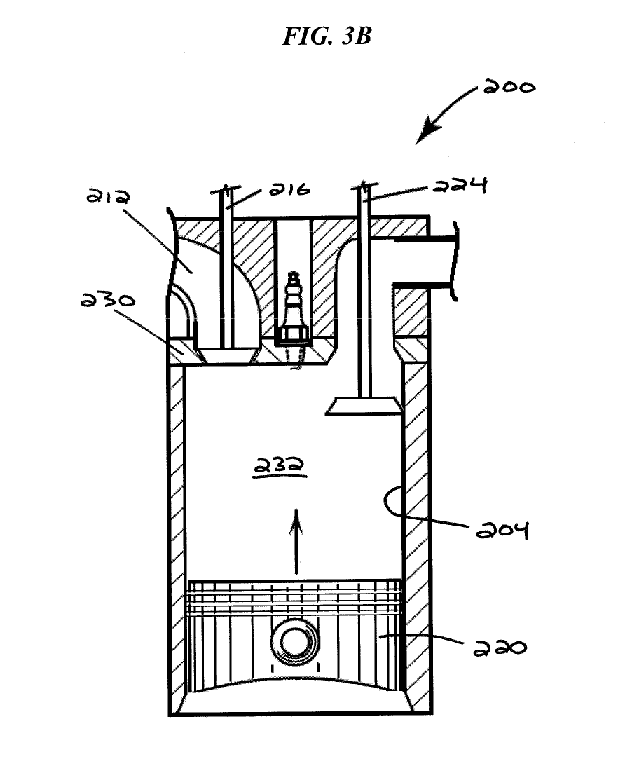

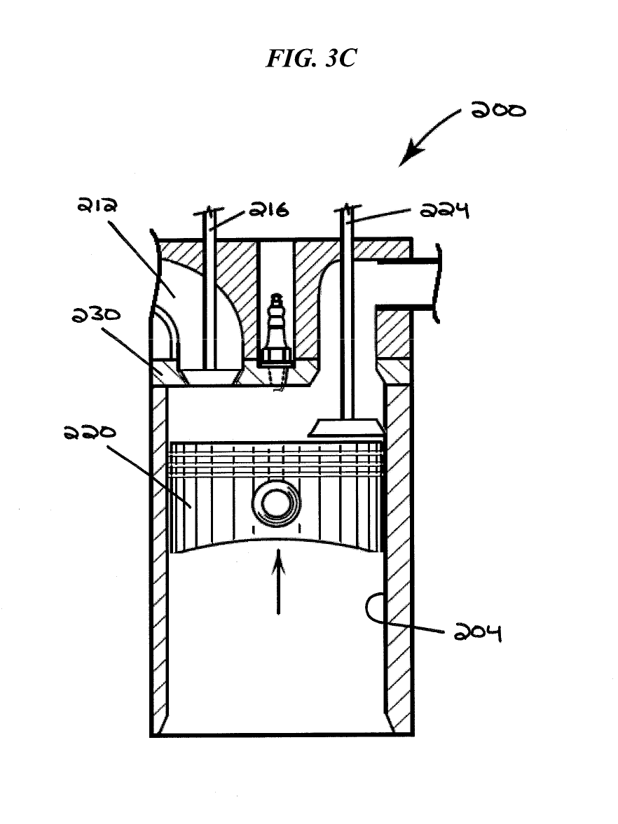

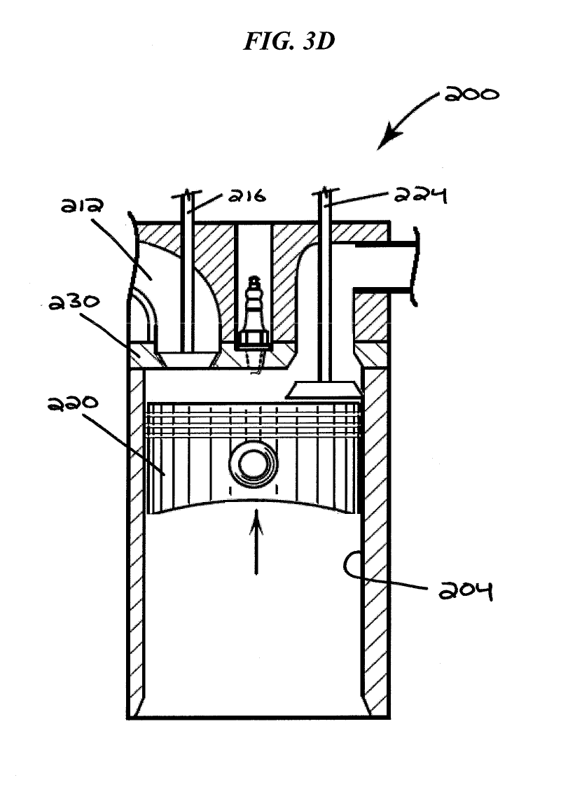

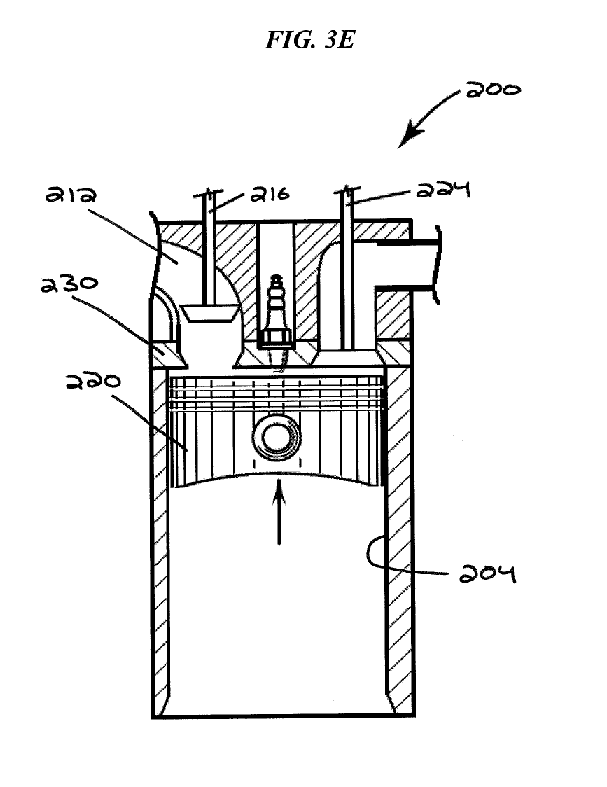

FIGS. 3A-3E illustrate the expansion side of the engine 200 at various points during an expansion stroke and an exhaust stroke following immediately thereafter.

As shown in FIG. 3A, the crossover expansion valve 216 and the exhaust valve 224 are both closed during the expansion stroke such that the expansion cylinder 204 defines a substantially sealed combustion chamber 232 and the force of combustion drives the expansion piston 220 down in the direction of the illustrated arrow. As the expansion piston 220 approaches its BDC position, the expansion cylinder 204 is filled with hot exhaust gasses and other combustion products.

As shown in FIG. 3B, at or about the time that the expansion piston 220 reaches its BDC position, the exhaust valve 224 is opened while the crossover expansion valve 216 remains closed and the expansion piston 220 begins to ascend in an exhaust stroke. During the exhaust stroke, hot gasses generated during the combustion event are driven out of the expansion cylinder 204 through the open exhaust valve 224 by the ascending piston 220. The exhaust valve 224 can also open earlier, for example about 60 CA degrees before the expansion piston 220 reaches its BDC position.

The engine 200 has a very low clearance space between the expansion piston 220 and the firing deck of the cylinder head 230 when the expansion piston is at its TDC position. This low clearance space maximizes the effective expansion ratio of air and/or fuel entering the expansion cylinder 204 from the crossover passage 212, thereby increasing the efficiency of the engine 200. As a result of this small clearance space, however, valve opening and closing timings must be selected carefully to avoid contact between the expansion piston 220 and the inwardly-opening exhaust valve 224.

Accordingly, as shown in FIG. 3C, the exhaust valve 224 begins to close just before the ascending expansion piston 220 makes contact with the valve head. Preferably, the initiation of the exhaust valve 224 closing event occurs just before contact is made, such that the rising expansion piston 220 “chases” the rising exhaust valve 224, as shown in FIG. 3D. In other words, the exhaust valve 224 is held open as long as possible to maximize the amount of exhaust gas that is evacuated from the expansion cylinder 204.

As shown in FIG. 3E, once the exhaust valve 224 is closed, and after a short delay, the crossover expansion valve 216 is opened to supply a fresh charge of air and/or fuel to the expansion cylinder 204 for a subsequent expansion stroke.

Preferably, the exhaust valve 224 is closed about 0 CA degrees to about 15 CA degrees before the crossover expansion 216 valve is opened. More preferably, the exhaust valve 224 is closed about 3 CA degrees to about 10 CA degrees before the crossover expansion valve 216 is opened. Even more preferably, the exhaust valve 224 is closed about 3 CA degrees to about 5 CA degrees before the crossover expansion valve 216 is opened. In one embodiment, the exhaust valve 224 is closed about 4 CA degrees before the crossover expansion valve 216 is opened.

In the illustrated embodiment, the exhaust valve 224 is closed and the crossover expansion valve 216 is opened before the expansion piston 220 reaches its TDC position. In other embodiments, however, the crossover expansion valve 216 can open shortly after the expansion piston 220 reaches its TDC position.

As will be appreciated from the foregoing, in the engine 200, the exhaust valve 224 is closed as late as possible (e.g., as close to TDC of the expansion piston 220 as possible, just before contact between the exhaust valve and the expansion piston occurs). Once exhaust valve 224 closing is initiated, the exhaust valve 224 is closed as quickly as possible. The crossover expansion valve 216 can then be opened within about 15 CA degrees from the exhaust valve 224 closing. This valve timing relationship advantageously avoids pre-ignition, piston-to-valve contact, and blow through, while at the same time improving engine efficiency.

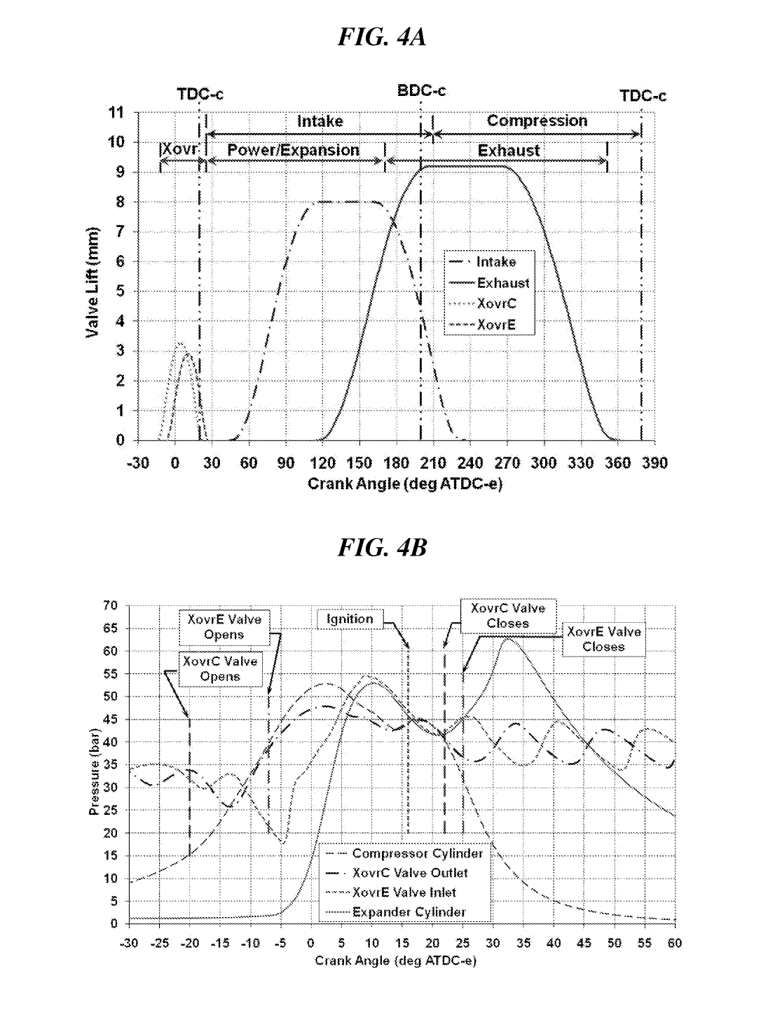

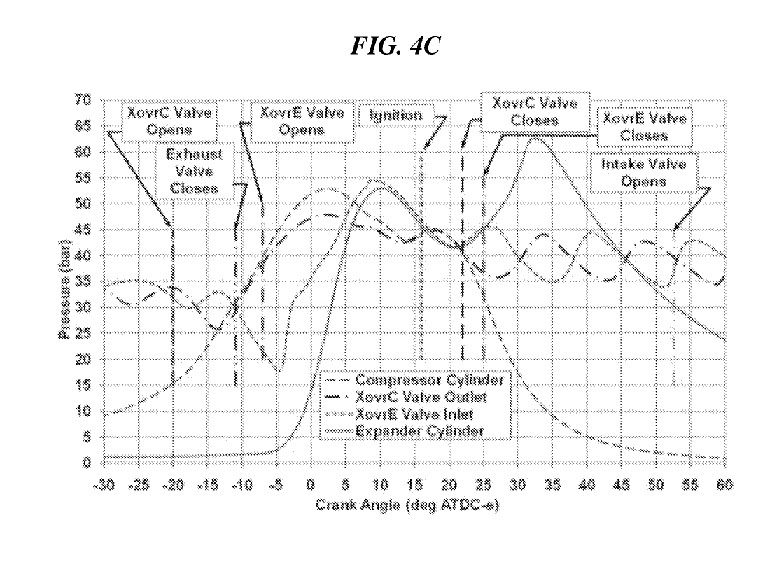

FIGS. 4A-4C graphically illustrate valve opening and closing timings for one exemplary embodiment of a split-cycle engine having improved exhaust valve timing. In FIG. 4A, valve lift is plotted as a function of crank angle degrees after top dead center of the expansion piston “deg ATDC-e” over a 420 CA degree portion of the engine's operating cycle. In FIGS. 4B and 4C, pressure observed at four locations within the engine (compressor cylinder, XovrC valve outlet, XovrE valve inlet, and expander cylinder) is plotted as a function of deg ATDC-e over a 90 CA degree portion of the engine's operating cycle. The labeled vertical dashed lines in FIGS. 4B-4C indicate the timing at which ignition occurs and the timing at which the various engine valves open and close. As shown, the exhaust valve closes at about −11 deg ATDC-e. The crossover expansion valve opens at about −7 deg ATDC-e. Accordingly, in the illustrated embodiment, the crossover expansion valve opens approximately 4 CA degrees after the exhaust valve closes.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. An engine comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including at least a crossover expansion valve disposed therein; and
an exhaust valve through which exhaust gasses can be evacuated from the expansion cylinder;
wherein the crossover expansion valve is opened between about 0 CA degrees and about 15 CA degrees after the exhaust valve is closed.

2. The engine of claim 1, wherein the crossover expansion valve is opened between about 3 CA degrees and about 10 CA degrees after the exhaust valve is closed.

3. The engine of claim 1, wherein the crossover expansion valve is opened between about 3 CA degrees and about 5 CA degrees after the exhaust valve is closed.

4. The engine of claim 1, wherein the crossover expansion valve is opened about 4 CA degrees after the exhaust valve is closed.

5. The engine of claim 1, wherein the crossover expansion valve controls fluid flow between the crossover passage and the expansion cylinder.

6. The engine of claim 1, wherein the crossover expansion valve is outwardly-opening.

7. The engine of claim 1, wherein the exhaust valve is inwardly-opening.

8. The engine of claim 1, wherein the exhaust valve is closed before the expansion piston reaches its TDC position.

9. The engine of claim 1, wherein the crossover expansion valve is opened before the expansion piston reaches its TDC position.

10. The engine of claim 1, wherein the crossover expansion valve is opened after the expansion piston reaches its TDC position.

11. A method of operating a split-cycle engine comprising:
opening an exhaust valve of the engine during an exhaust stroke such that exhaust gasses are evacuated from an expansion cylinder of the engine through the exhaust valve;
closing the exhaust valve during the exhaust stroke and before an expansion piston disposed in the expansion cylinder reaches its TDC position; and
opening a crossover expansion valve of the engine between about 0 CA degrees and about 15 CA degrees after closing the exhaust valve such that air flows from a crossover passage of the engine, through the crossover expansion valve, and into the expansion cylinder.

12. The method of claim 11, wherein the crossover expansion valve is opened between about 3 CA degrees and about 10 CA degrees after the exhaust valve is closed.

13. The method of claim 11, wherein the crossover expansion valve is opened between about 3 CA degrees and about 5 CA degrees after the exhaust valve is closed.

14. The method of claim 11, wherein the crossover expansion valve is opened about 4 CA degrees after the exhaust valve is closed.

15. The method of claim 11, wherein the crossover expansion valve is outwardly-opening.

16. The method of claim 11, wherein the exhaust valve is inwardly-opening.

17. The method of claim 11, wherein the crossover expansion valve is opened before the expansion piston reaches its TDC position.

18. The method of claim 11, wherein the crossover expansion valve is opened after the expansion piston reaches its TDC position.
